(19) United States
(12) Patent Application Publication
(10) Pub. No.: US 2026/0244306 A1
(43) Pub. Date: Aug. 20, 2026

(54) CONTENT DISPLAY METHOD, APPARATUS, READABLE MEDIUM, ELECTRONIC DEVICE, AND PROGRAM PRODUCT

(71) Applicant: Beijing Youzhuju Network Technology Co., Ltd., Beijing (CN)

(72) Inventors: Junlin CAI, Beijing (CN); Haoran LI, Beijing (CN); Yijun LI, Beijing (CN); Jin BAI, Beijing (CN); Ling YANG, Beijing (CN)

(21) Appl. No.: 19/464,054

(22) Filed: Jan. 29, 2026

(30) Foreign Application Priority Data
Feb. 14, 2025 (CN) 202510170696.0

(51) Int. Cl. G06F 3/0481

(52) U.S. Cl. CPC G06F 3/0481

(57) ABSTRACT

A content display method and apparatus, a readable medium, an electronic device, and a program product. The method includes: playing multimedia content in a target page, and displaying an interactive component in the target page, where the interactive component is used for triggering display of a landing page associated with the multimedia content; and controlling the interactive component to perform different displays with playing of the multimedia content, where in a first playback stage of the multimedia content, the interactive component is used for displaying a preset visual effect, and in a second playback stage of the multimedia content, a first display area of the interactive component is used for displaying the preset visual effect, and a second display area of the interactive component is used for displaying text information and/or picture information related to the multimedia content.

### CROSS-REFERENCE TO RELATED APPLICATION(S)

This application claims priority to Chinese Application No. 202510170696.0 filed February 14, 2025, the disclosure of which is incorporated herein by reference in its entirety.

### TECHNICAL FIELD

The present disclosure relates to the field of computer technologies, and specifically, to a content display method, an apparatus, a readable medium, an electronic device, and a program product.

### BACKGROUND

With the development of computer technologies, functions that an application may provide for a user are more and more abundant. For example, in a feed application, when the user browses to target content associated with a landing page on a browsing page in the feed application, an interactive control for triggering display of the landing page is generally displayed on the browsing page, so that the user may view the landing page by triggering the interactive control.

### SUMMARY

The summary is provided so as to introduce the concepts in a brief form, and these concepts will be described in detail in the following part of detailed description. The summary is not intended to identify the key features or necessary features of the claimed technical solution, nor is intended to limit the scope of the claimed technical solution.

In a first aspect, the present disclosure provides a content display method, the content display method includes:

playing multimedia content in a target page, and displaying an interactive component in the target page, where the interactive component is used for triggering display of a landing page associated with the multimedia content; and

controlling the interactive component to perform different displays following playback of the multimedia content, where in a first playback stage of the multimedia content, the interactive component is used for displaying a preset effect, and in a second playback stage of the multimedia content, a first display area of the interactive component is used for displaying the preset effect, and a second display area of the interactive component is used for displaying text information and/or picture information related to the multimedia content.

In a second aspect, the present disclosure provides a content display apparatus, the content display apparatus includes:

a first display module, configured to play multimedia content in a target page, and display an interactive component in the target page, where the interactive component is used for triggering display of a landing page associated with the multimedia content; and

a second display module, configured to control the interactive component to perform different displays following the playback of the multimedia content, where in a first playback stage of the multimedia content, the interactive component is used for displaying a preset effect, and in a second playback stage of the multimedia content, a first display area of the interactive component is used for displaying the preset effect, and a second display area of the interactive component is used for displaying text information and/or picture information related to the multimedia content.

In a third aspect, the present disclosure provides a computer-readable medium having a computer program stored thereon, where the computer program, when executed by a processing apparatus, implements the steps of the method according to the first aspect.

In a fourth aspect, the present disclosure provides an electronic device, the electronic device includes:

a storage apparatus having a computer program stored thereon; and

a processing apparatus, configured to execute the computer program in the storage apparatus to implement the steps of the method according to the first aspect.

In a fifth aspect, the present disclosure provides a computer program product including a computer program, where the computer program, when executed by a processor, implements the steps of the method according to the first aspect.

Other features and advantages of the present disclosure will be described in detail in the following part of detailed description.

### BRIEF DESCRIPTION OF THE DRAWINGS

In combination with the drawings and with reference to the following specific embodiments, the above-mentioned and other features, advantages and aspects of various embodiments of the present disclosure will become more apparent. Throughout the drawings, the same or similar reference numbers refer to the same or similar elements. It should be understood that the drawings are schematic, and the components and elements are not necessarily drawn to scale. In the drawings:

FIG. 1 shows a schematic diagram of display of an interactive component in the related art;

FIG. 2 is a flowchart of a content display method according to an exemplary embodiment of the present disclosure;

FIG. 3 is a schematic diagram of display of an interactive component according to an exemplary embodiment of the present disclosure;

FIG. 4 is a schematic diagram of display of an interactive component according to an exemplary embodiment of the present disclosure;

FIG. 5 is a schematic diagram of display of an interactive component according to an exemplary embodiment of the present disclosure;

FIG. 6 is a schematic diagram of display of an interactive component according to an exemplary embodiment of the present disclosure;

FIG. 7 is a flowchart of another content display method according to an exemplary embodiment of the present disclosure;

FIG. 8 is a block diagram of a content display apparatus according to an exemplary embodiment of the present disclosure; and

FIG. 9 is a schematic structural diagram of an electronic device according to an exemplary embodiment of the present disclosure.

### DETAILED DESCRIPTION OF EMBODIMENTS

Embodiments of the present disclosure will be described in more detail below with reference to the drawings. Although certain embodiments of the present disclosure are shown in the drawings, it should be understood that the present disclosure may be implemented in various forms, and should not be construed as limited to the embodiments set forth herein; on the contrary, these embodiments are provided for a more thorough and complete understanding of the present disclosure. It should be understood that the drawings and embodiments of the present disclosure are only used for illustrative purposes, and are not used to limit the protection scope of the present disclosure.

It should be understood that the various steps described in the method implementations of the present disclosure may be performed in different orders, and/or performed in parallel. In addition, the method implementations may include additional steps and/or omit the execution of the steps shown. The scope of the present disclosure is not limited in this regard.

The term "include/comprise" and its variants used herein are open-ended inclusions, that is, "include/comprise but not limited to". The term "based on" is "at least partially based on". The term "one embodiment" means "at least one embodiment"; the term "another embodiment" means "at least one other embodiment"; the term "some embodiments" means "at least some embodiments". Relevant definitions of other terms will be given in the following description.

It should be noted that concepts such as "first" and "second" mentioned in the present disclosure are only used to distinguish different apparatuses, modules or units, and are not used to limit the order of functions performed by these apparatuses, modules or units, or interdependence therebetween.

It should be noted that the modifiers of "one" and "a plurality of" mentioned in the present disclosure are illustrative rather than restrictive, and those skilled in the art should understand that unless otherwise clearly indicated in the context, they should be understood as "one or more".

The names of messages or information exchanged between multiple apparatuses in the implementations of the present disclosure are only used for illustrative purposes, and are not used to limit the scope of these messages or information.

It may be understood that before using the technical solutions disclosed in various embodiments of the present disclosure, the user shall be informed of the type, range of use, use scenarios, etc. of personal information involved in the present disclosure in an appropriate manner and the authorization of the user shall be obtained in accordance with relevant laws and regulations.

For example, in response to receiving an active request from a user, prompt information is sent to the user to clearly prompt the user that the requested operation will require access to and use of the user's personal information. In this way, the user may independently choose, according to the prompt information, whether to provide the personal information to software or hardware, such as an electronic device, an application, a server, or a storage medium, that performs the operations of the technical solutions of the present disclosure.

As an optional but non-limiting implementation, in response to receiving the active request from the user, the prompt information may be sent to the user in the form of, for example, a pop-up window, and the prompt information may be presented in text in the pop-up window. In addition, the pop-up window may also carry a selection control for the user to choose whether to "agree" or "disagree" to provide the personal information to the electronic device.

It may be understood that the above process of notifying and obtaining user authorization is only illustrative, and does not constitute a limitation on the implementations of the present disclosure, and other methods that satisfy the relevant laws and regulations may also be applied to the implementations of the present disclosure.

Meanwhile, it may be understood that the data involved in the technical solution (including but not limited to the data itself, acquisition or use of the data) shall comply with requirements of corresponding laws, regulations and related provisions.

As mentioned in the background, the interactive control in the related art has a problem of a single display style.

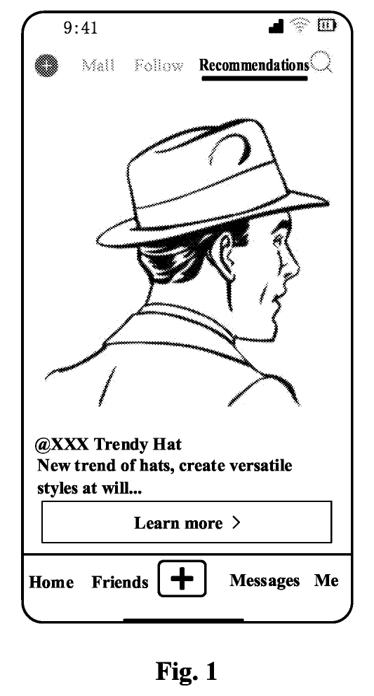

For example, in a short video application, when an advertisement video is browsed on a video playback page in the short video application, an interactive control for triggering display of main content in the advertisement video may be displayed on the video playback page. Since interactive controls in different advertisement videos have a same display style, as shown in FIG. 1, there exist problems of a single display style, poor interaction experience and so on.

To overcome the above technical problem, the display style of the interactive control may be produced synchronously when video content is produced, so that a personalized interactive control may be displayed in the video content. However, since the production of the interactive control is complicated, there exist problems of great difficulty in production, long production time and so on. At the same time, since the interactive control is displayed in the video content in a fixed style after the production is completed, there also exist problems of a single display style, poor interaction experience and so on.

In view of this, the present disclosure provides a content display method, an apparatus, a readable medium, an electronic device, and a program product to solve the above problems.

The embodiments of the present disclosure will be further explained below in combination with the drawings.

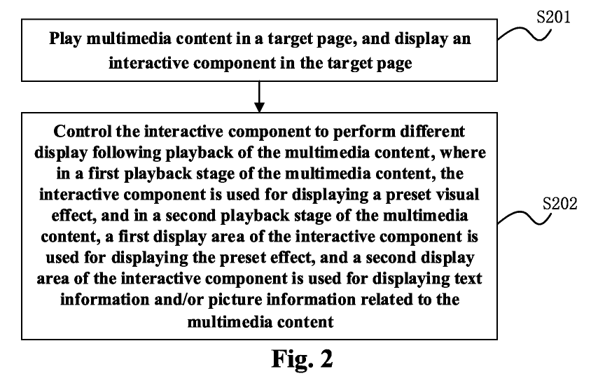

FIG. 2 is a flowchart of a method according to an exemplary embodiment of the present disclosure. Referring to FIG. 2, the method may include the following steps:

S201: multimedia content is displayed in a target page, and an interactive component is displayed in the target page, where the interactive component is used for triggering display of a landing page associated with the multimedia content.

In the embodiment, the target page may be a feed page in a feed application, for example, may be a video playback page in a short video application or an audio playback page in an audio application, and certainly, the target page may also be a page in other applications, which is not limited in the embodiments of the present disclosure. Correspondingly, the multimedia content may be display content provided by the feed application, for example, when the feed application is the short video application, the multimedia content may be a short video associated with a landing page; and when the feed application is the audio application, the multimedia content may be audio associated with a landing page.

That is to say, in a possible implementation, playing the multimedia content in the target page, and displaying the interactive component in the target page may include:

displaying the feed page, where the feed page is used for a user to continuously browse a plurality of video content items; and in response to a browsing operation of the user on the feed page, playing the multimedia content in the target page, and displaying the interactive component on an upper layer of the multimedia content.

Exemplarily, when a short video application is opened in a terminal device, a video playback page for a user to continuously browse a plurality of short video content items may be displayed, and when the user browses to an advertisement video associated with a landing page on the video playback page, an interactive component is displayed on an upper layer of the advertisement video.

S202: the interactive component is controlled to perform different displays following playback of the multimedia content, where in a first playback stage of the multimedia content, the interactive component is used for displaying a preset effect, and in a second playback stage of the multimedia content, a first display area of the interactive component is used for displaying the preset effect, and a second display area of the interactive component is used for displaying text information and/or picture information related to the multimedia content.

In the embodiment, the preset effect, the text information and the picture information may be determined according to actual situations, which is not limited in the embodiments of the present disclosure.

For example, in the field of advertisement, the multimedia content may be an advertisement video, and accordingly, the preset effect may be a flowing light effect, a falling snowflake effect, a falling petal effect or the like, the text information may include advertisement copy of the advertisement video, a brand slogan associated with the advertisement video, selling point information and/or discount information of a main product in the advertisement video, and the picture information may include a brand logo associated with the advertisement video, a product picture of the main product in the advertisement video, and so on.

In the embodiment, the first playback stage and the second playback stage may refer to playback duration of the multimedia content, may also refer to playing content frames of the multimedia content, and may certainly refer to others, which is not limited in the embodiments of the present disclosure.

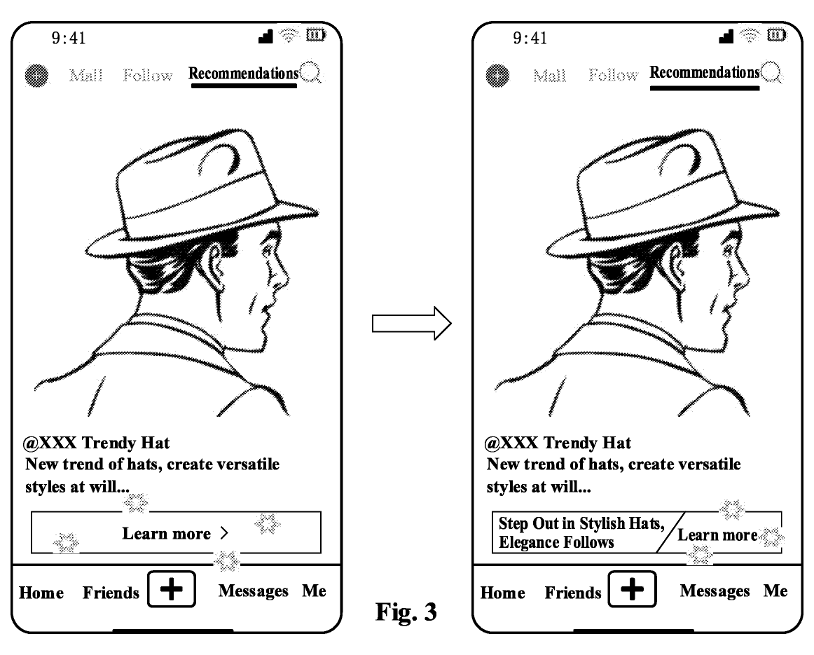

For example, still referring to the above example, when the playback duration of the advertisement video on the video playback page does not reach a first preset duration, the falling snowflake effect is displayed in the interactive component "Learn more"; and when the playback duration of the advertisement video on the video playback page exceeds the first preset duration, the preset effect is displayed in the first display area of the interactive component "Learn more", and the text information "Step out in stylish hats, elegance follows" is displayed in the second display area of the interactive component "Learn more", as shown in FIG. 3.

Through the above technical solution, the interactive component may be controlled to perform different displays following the playback of the multimedia content, and therefore, not only the display style of the interactive component may be enriched, the browsing experience of the user may be improved, but also the attention of the user may be attracted, so that the user may quickly notice the interactive component, thereby increasing the interaction experience of the user. In addition, following the playback of the multimedia content, the preset effect may be displayed first in the interactive component, and then the preset effect and the text information and/or the picture information related to the multimedia content are displayed in different areas of the interactive component, therefore, following the playback of the multimedia content, the attention of the user may be attracted to the interactive component through the preset effect first, and then the user may quickly understand the multimedia content through the text information and/or the picture information, thereby further increasing the interaction experience of the user.

In order to facilitate understanding of the content display method provided by the present disclosure, the following describes possible implementations in the present disclosure.

In a possible implementation, controlling the interactive component to perform different displays following the playback of the multimedia content may include:

controlling the interactive component to display a first preset effect when the multimedia content is in the first playback stage within a first duration; and controlling the interactive component to display a second preset effect when the multimedia content is in the first playback stage within a second duration, where the second preset effect is different from the first preset effect.

In the embodiment, the first duration, the second duration, the first preset effect and the second preset effect may all be set according to actual situations, which is not limited in the embodiments of the present disclosure. Exemplarily, the first duration and the second duration may be determined according to festivals, and the preset effect may be determined according to the festivals corresponding to different durations, so that the preset effect may match the atmosphere of the corresponding festival, thereby further improving the browsing experience of the user. For example, during a first festival, the first preset effect may be a red envelope rain effect, and therefore, when the multimedia content is in the first playback stage, the interactive component may be controlled to display the red envelope rain effect. During a second festival, the second preset effect may be a falling petal effect, and therefore, when the multimedia content is in the first playback stage, the interactive component may be controlled to display the falling petal effect.

Through the above method, the interactive component may be controlled to display different effects in the first playback stage corresponding to different durations, which may further improve the diversity of effects in the interactive component and enrich the display style of the interactive component, and on the other hand, may further improve the browsing experience and interaction experience of the user.

In a possible implementation, controlling the interactive component to perform different displays following the playback of the multimedia content may include:

displaying a preset color effect in the interactive component when the multimedia content is in the first playback stage; and

accordingly, the content display method may further include:

displaying a preset animation effect in the interactive component and/or at a preset position around the interactive component when the multimedia content is in the first playback stage.

In the embodiment, the preset color effect may be a solid color effect, such as a flowing light effect, may also be a color effect, such as a gradient color effect, and may certainly be other color effects, which is not limited in the embodiments of the present disclosure.

In the embodiment, the preset color effect may be one color effect or multiple color effects. When the preset color effect includes multiple color effects, the multiple color effects may be sequentially displayed based on a preset display order, or may be randomly displayed, which is not limited in the embodiments of the present disclosure.

In the embodiment, the preset animation effect may be a falling petal effect, a falling snowflake effect, a jumping note effect, or the like, which is specifically determined according to an actual situation, and is not limited in the embodiments of the present disclosure.

In the embodiment, the preset position around the interactive component may be at least one of above, below, left or right of the interactive component, which is not limited in the embodiments of the present disclosure.

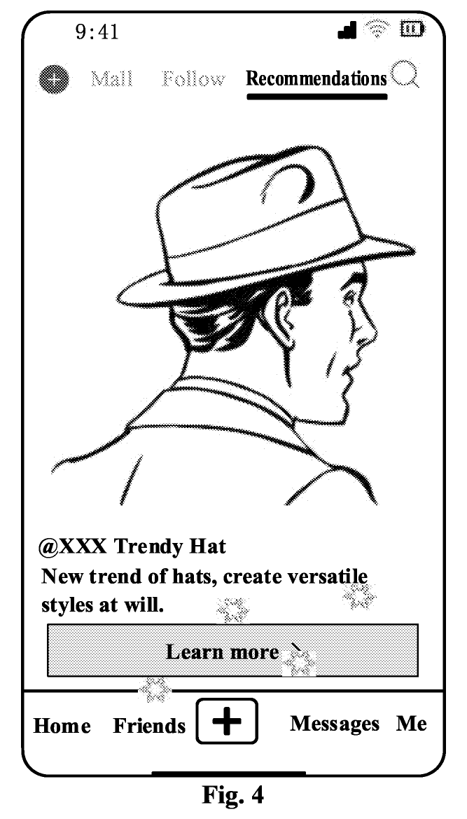

For example, still referring to the above example, when the playback duration of the advertisement video on the video playback page does not exceed the first preset duration, a flowing light effect of gradually fading light gray may be displayed in the interactive component "Learn more", and a effect of snowflakes falling from top to bottom may be displayed above the interactive component, as shown in FIG. 4.

In a possible implementation, controlling the interactive component to perform different displays following the playback of the multimedia content may include:

displaying a plurality of text information items and/or a plurality of picture information items related to the multimedia content in the second display area of the interactive component in a carousel when the multimedia content is in the second playback stage.

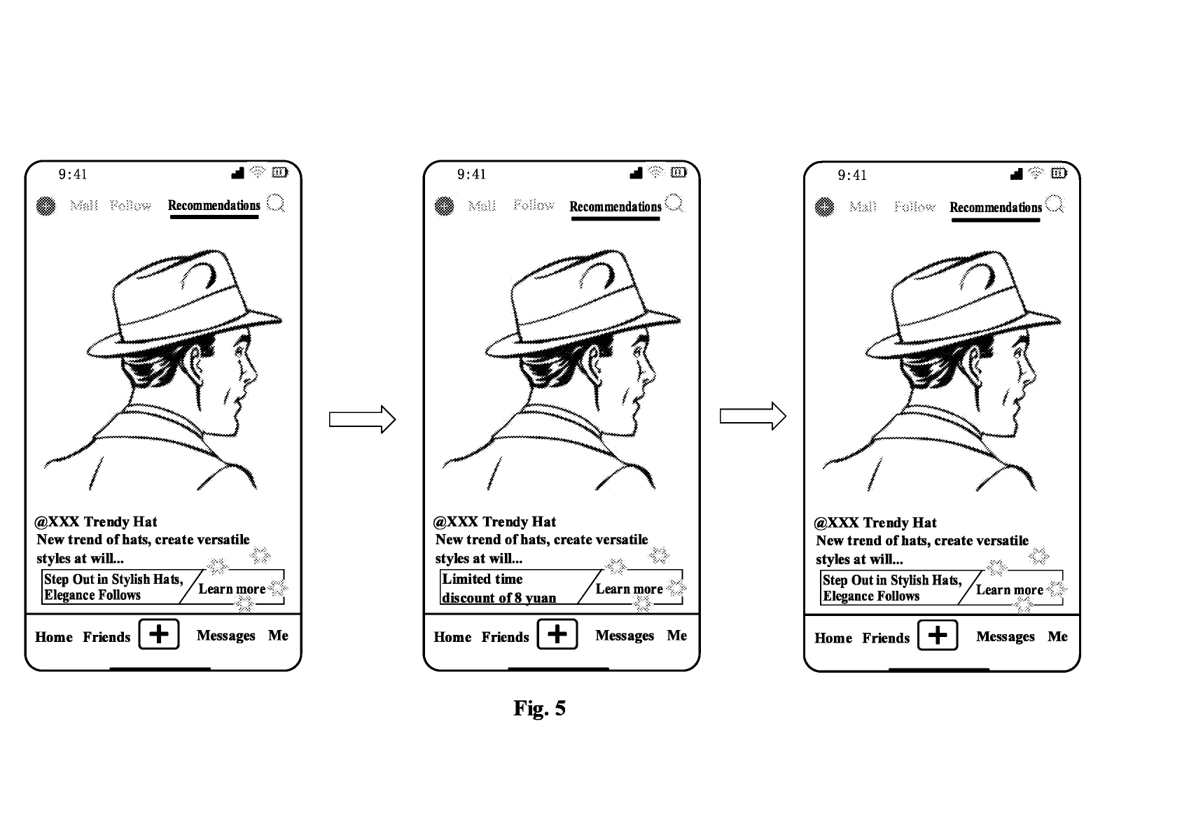

For example, still referring to the above example, when the playback duration of the advertisement video on the video playback page exceeds the first preset duration, the preset effect may be displayed in the first display area of the interactive component "Learn more", and the text information "Step out in stylish hats, elegance follows" is displayed in the second display area of the interactive component "Learn more". When the display duration of "Step out in stylish hats, elegance follows" reaches a preset display duration, "Step out in stylish hats, elegance follows" may be changed to the text information "Limited time discount of 8 yuan", and when the display duration of "Limited time discount of 8 yuan" reaches the preset display duration, "Limited time discount of 8 yuan" may be changed back to "Step out in stylish hats, elegance follows", as shown in FIG. 5.

Through the above method, the plurality of text information items and/or the plurality of picture information items related to the multimedia content may be displayed in a carousel in the second display area, and therefore, the content display in the interactive component may be further enriched, the display flexibility of the display content in the interactive component may be improved, and the browsing experience of the user may be further improved.

In a possible implementation, the preset effect includes a flowing light effect, and/or when the multimedia content is video content, a color of the preset effect is determined according to a main hue of the video content.

Exemplarily, in order to highlight the interactive component in the target page, so that the user may quickly notice the interactive component in the target page, the color of the preset effect may be different from the main hue of the video content. For example, when the main hue of the video content is yellow, the color of the preset effect may be red or orange.

Exemplarily, in order to improve the coordination of the display content in the target page, the color of the preset effect may be the same or similar to the main hue of the video content. For example, when the main hue of the video content is red, the color of the preset effect may be red.

In a possible implementation, controlling the interactive component to perform different displays following the playback of the multimedia content may include:

controlling the interactive component to display a preset initial style when the multimedia content is in a third playback stage, where the third playback stage is before the first playback stage, and the first playback stage is before the second playback stage.

In the embodiment, the initial style may be determined according to an actual situation, which is not limited in the embodiments of the present disclosure.

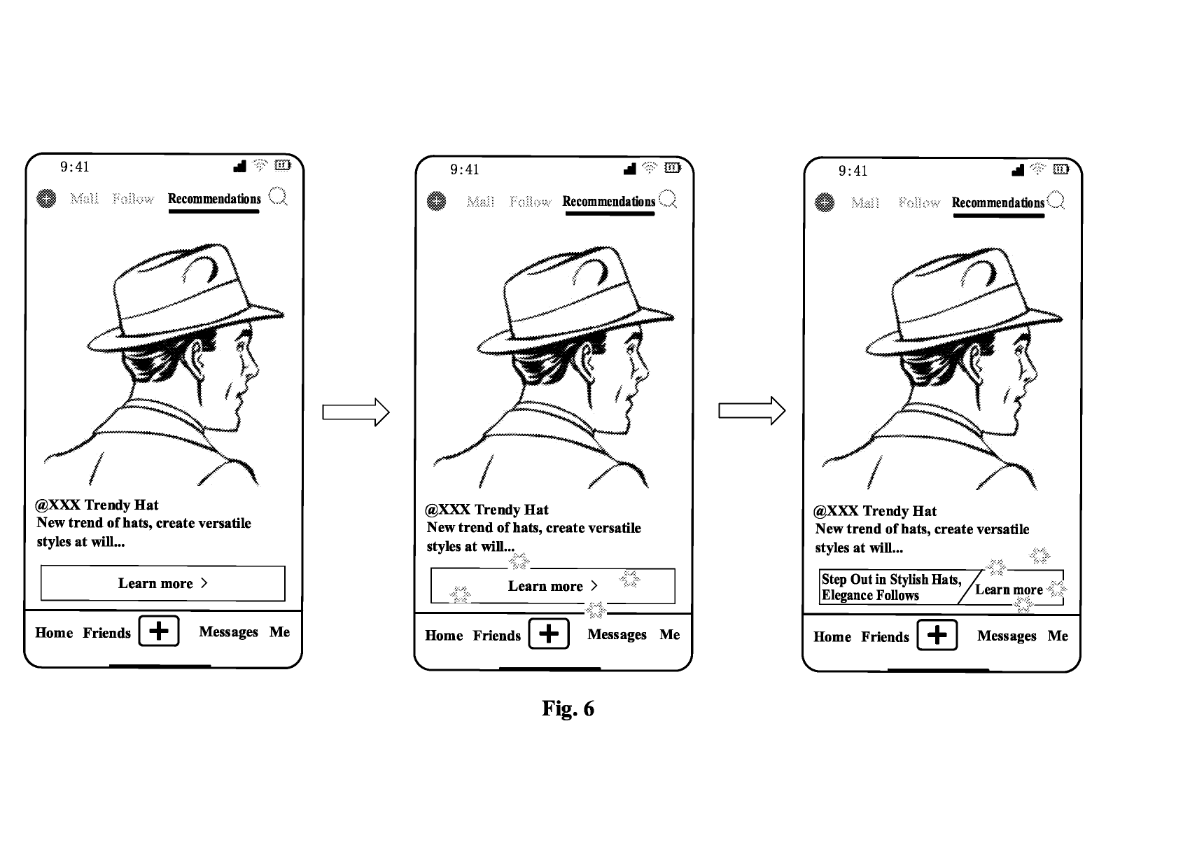

For example, in order that the user may focus more on the multimedia content when the multimedia content is in the third playback stage, the initial style may be using a light color as a background color of the interactive component or no preset effect. Therefore, after the multimedia content is displayed in the target page, if the multimedia content is in the third playback stage, the interactive component without effect may be displayed; if the multimedia content is in the first playback stage, the falling snowflake effect may be displayed in the interactive component; if the multimedia content is in the second playback stage, the falling snowflake effect may be displayed in the first display area of the interactive component, and the text information "Step out in stylish hats, elegance follows" may be displayed in the second display area of the interactive component, as shown in FIG. 6.

In order to further facilitate understanding of the content display method provided by the present disclosure, the following further describes the content display method provided by the present disclosure in combination with various steps:

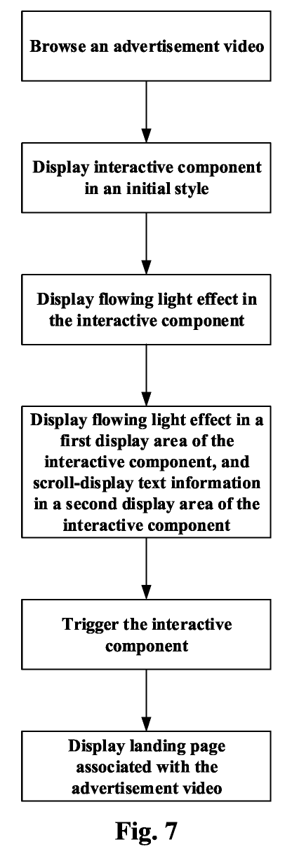

For example, as shown in FIG. 7, when a user opens a short video application, a video playback page in the short video application for browsing videos may be displayed first, and when an advertisement video is browsed on the video playback page, an interactive component in an initial style, for example, an interactive component without effect, is displayed on an upper layer of the advertisement video. When the playback duration of the advertisement video on the video playback page reaches a first playback duration, for example, 1 second, a flowing light effect may be displayed in the interactive component. When the playback duration of the advertisement video on the video playback page reaches a second playback duration, for example, 4 seconds, the flowing light effect may be displayed in the first display area of the interactive component, and the text information related to the advertisement video may be scroll-displayed in the second display area of the interactive component, for example, the text information "Step out in stylish hats, elegance follows", "Wish all people in China a happy Chinese New Year", and "Limited time discount of 8 yuan" may be scroll-displayed. If the playback duration of the advertisement video on the video playback page reaches 8 seconds, when the user triggers the interactive component through an operation such as clicking, the landing page associated with the advertisement video may be displayed.

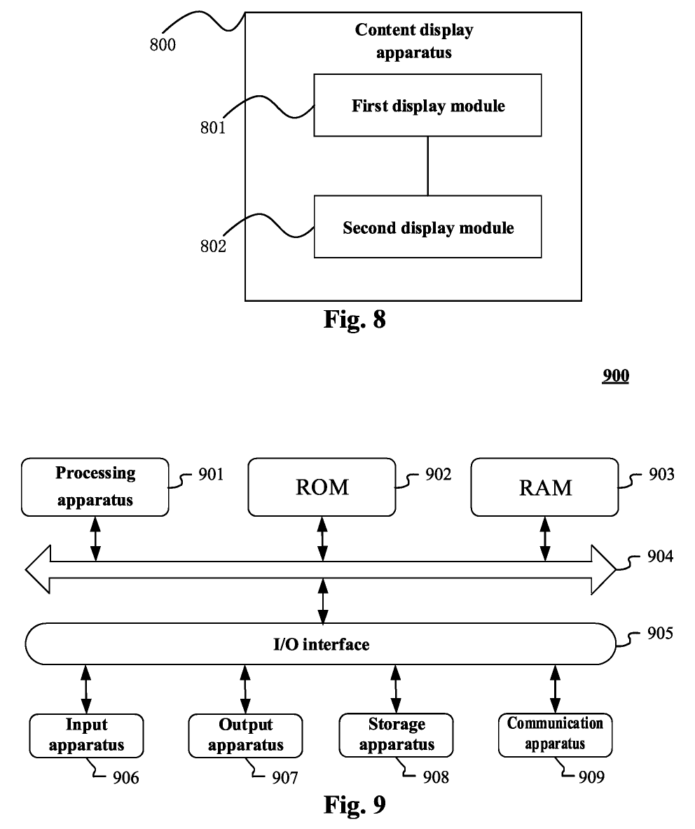

Based on the same concept, an embodiment of the present disclosure further provides a content display apparatus, and as shown in FIG. 8, the content display apparatus 800 may include:

a first display module 801, configured to play multimedia content in a target page, and display an interactive component in the target page, where the interactive component is used for triggering display of a landing page associated with the multimedia content; and

a second display module 802, configured to control the interactive component to perform different displays following playback of the multimedia content, where in a first playback stage of the multimedia content, the interactive component is used for displaying a preset effect, and in a second playback stage of the multimedia content, a first display area of the interactive component is used for displaying the preset effect, and a second display area of the interactive component is used for displaying text information and/or picture information related to the multimedia content.

Through the above content display apparatus 800, the interactive component may be controlled to perform different displays following the playback of the multimedia content, and therefore, not only the display style of the interactive component may be enriched, the browsing experience of the user may be improved, but also the attention of the user may be attracted, so that the user may quickly notice the interactive component, thereby increasing the interaction experience of the user. In addition, following the playback of the multimedia content, the preset effect may be displayed first in the interactive component, and then the preset effect and the text information and/or the picture information related to the multimedia content are displayed in different areas of the interactive component, therefore, following the playback of the multimedia content, the attention of the user may be attracted to the interactive component through the preset effect first, and then the user may quickly understand the multimedia content through the text information and/or the picture information, thereby further increasing the interaction experience of the user.

In a possible implementation, the second display module 802 may include:

a first display unit, configured to control the interactive component to display a first preset effect when the multimedia content is in the first playback stage within a first duration; and

a first display unit, configured to control the interactive component to display a second preset effect when the multimedia content is in the first playback stage within a second duration, where the second preset effect is different from the first preset effect.

In a possible implementation, the second display module 802 may be configured to display a preset color effect in the interactive component when the multimedia content is in the first playback stage; and accordingly, the content display apparatus 800 may further include:

a third display module, configured to display a preset animation effect in the interactive component and/or at a preset position around the interactive component when the multimedia content is in the first playback stage.

In a possible implementation, the second display module 802 may be configured to display a plurality of text information items and/or a plurality of picture information items related to the multimedia content in the second display area of the interactive component in a carousel when the multimedia content is in the second playback stage.

In a possible implementation, the preset effect may include a flowing light effect, and/or when the multimedia content is video content, a color of the preset effect is determined according to a main hue of the video content.

In a possible implementation, the second display module 802 may be configured to control the interactive component to display a preset initial style when the multimedia content is in a third playback stage, where the third playback stage is before the first playback stage, and the first playback stage is before the second playback stage.

In a possible implementation, the first display module 801 may include:

a third display unit, configured to display a feed page, where the feed page is used for a user to continuously browse a plurality of video content items; and

a fourth display unit, configured to play the multimedia content in the target page, and display the interactive component on an upper layer of the multimedia content in response to a browsing operation of the user on the feed page.

Based on the same concept, an embodiment of the present disclosure further provides a computer-readable medium having a computer program stored thereon, where the program, when executed by a processing apparatus, implements the steps of any one of the above content display methods.

Based on the same concept, an embodiment of the present disclosure further provides an electronic device, which may include:

a storage apparatus having a computer program stored thereon; and

a processing apparatus, configured to execute the computer program in the storage apparatus to implement the steps of any one of the above content display methods.

Based on the same concept, an embodiment of the present disclosure further provides a computer program product including a computer program, where the computer program, when executed by a processor, implements the steps of any one of the above content display methods.

Reference is made to FIG. 9 below, which shows a schematic structural diagram of an electronic device 900 suitable for implementing the embodiments of the present disclosure. The terminal device in the embodiments of the present disclosure may include, but not limited to, mobile terminals such as a mobile phone, a laptop, a digital broadcast receiver, a PDA (personal digital assistant), a tablet computer, a PMP (portable multimedia player), a vehicle-mounted terminal (e.g., a vehicle navigation terminal), and the like, and fixed terminals such as a digital TV, a desktop computer, and the like. The electronic device shown in FIG. 9 is only an example, and should not impose any limitation on the function and scope of use of the embodiments of the present disclosure.

As shown in FIG. 9, the electronic device 900 may include a processing apparatus (e.g., a central processing unit, a graphics processing unit, etc.) 901, which may perform various appropriate actions and processing according to a program stored in a read-only memory (ROM) 902 or a program loaded from a storage apparatus 908 into a random access memory (RAM) 903. The RAM 903 further stores various programs and data required for operations of the electronic device 900. The processing apparatus 901, the ROM 902, and the RAM 903 are interconnected by means of a bus 904. An input/output (I/O) interface 905 is also connected to the bus 904.

Generally, the following apparatuses may be connected to the I/O interface 905: an input apparatus 906 including, for example, a touch screen, a touchpad, a keyboard, a mouse, a camera, a microphone, an accelerometer, a gyroscope, etc.; an output apparatus 907 including, for example, a liquid crystal display (LCD), a speaker, a vibrator, etc.; the storage apparatus 908 including, for example, a magnetic tape, a hard disk, etc.; and a communication apparatus 909. The communication apparatus 909 may allow the electronic device 900 to perform wireless or wired communication with other devices to exchange data. Although FIG. 9 shows the electronic device 900 having various apparatuses, it should be understood that it is not required to implement or have all of the illustrated apparatuses. Alternatively, more or fewer apparatuses may be implemented or provided.

In particular, according to the embodiments of the present disclosure, the process described above with reference to the flowchart may be implemented as a computer software program. For example, the embodiments of the present disclosure include a computer program product, which includes a computer program carried on a non-transitory computer-readable medium, and the computer program contains program code for executing the method shown in the flowchart. In such an embodiment, the computer program may be downloaded and installed from a network through the communication apparatus 909, or installed from the storage apparatus 908, or installed from the ROM 902. When the computer program is executed by the processing apparatus 901, the above-mentioned functions defined in the method of the embodiments of the present disclosure are executed.

It should be noted that the above computer-readable medium in the present disclosure may be a computer-readable signal medium, a computer-readable storage medium, or any combination thereof. The computer-readable storage medium may be, for example, but not limited to, an electrical, magnetic, optical, electromagnetic, infrared, or semiconductor system, apparatus or device, or any combination of the above. More specific examples of the computer-readable storage medium may include, but not limited to: an electrical connection having one or more conductors, a portable computer magnetic disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the above. In the present disclosure, a computer-readable storage medium may be any tangible medium that contains or stores a program, and the program may be used by or in combination with an instruction execution system, apparatus or device. In the present disclosure, a computer-readable signal medium may include a data signal propagated on a baseband or as a part of a carrier wave, and computer-readable program code is carried therein. This propagated data signal may take many forms, including but not limited to, an electromagnetic signal, an optical signal, or any suitable combination of the above. The computer-readable signal medium may also be any computer-readable medium other than the computer-readable storage medium, and the computer-readable signal medium may send, propagate, or transmit the program used by or in combination with the instruction execution system, apparatus or device. The program code contained on the computer-readable medium may be transmitted by any suitable medium, including but not limited to: wire, optical cable, radio frequency (RF), etc., or any suitable combination of the above.

In some implementations, any currently known or future developed network protocol, such as the hypertext transfer protocol (HTTP), may be used for communication, and may be interconnected with any form or medium of digital data communication (for example, a communication network). Examples of the communication network include a local area network ("LAN"), a wide area network ("WAN"), an internet (for example, the Internet), a peer-to-peer network (for example, an Ad-Hoc network), and any network currently known or to be developed in the future.

The above computer-readable medium may be included in the above electronic device, or may exist alone without being assembled into the electronic device.

The above computer-readable medium carries one or more programs, and when the one or more programs are executed by the electronic device, the electronic device is caused to: play multimedia content in a target page, and display an interactive component in the target page, where the interactive component is used for triggering display of a landing page associated with the multimedia content; and control the interactive component to perform different displays following playback of the multimedia content, where in a first playback stage of the multimedia content, the interactive component is used for displaying a preset effect, and in a second playback stage of the multimedia content, a first display area of the interactive component is used for displaying the preset effect, and a second display area of the interactive component is used for displaying text information and/or picture information related to the multimedia content.

The computer program code for performing the operations of the present disclosure may be written in one or more programming languages or a combination thereof, the programming languages including, but not limited to, object-oriented programming languages such as Java, Smalltalk, C++, and conventional procedural programming languages such as "C" language or similar programming languages. The program code may be executed entirely on a user's computer, partly on the user's computer, as a stand-alone software package, partly on the user's computer and partly on a remote computer, or entirely on the remote computer or server. In the case of involving a remote computer, the remote computer may be connected to the user's computer through any kind of network, including a local area network (LAN) or a wide area network (WAN), or may be connected to an external computer (for example, connected through the Internet using an Internet service provider).

The flowcharts and block diagrams in the drawings illustrate the possibly implemented architectures, functions, and operations of the system, the method, and the computer program product according to various embodiments of the present disclosure. In this regard, each block in the flowchart or block diagram may represent a module, program segment, or part of code, which contains one or more executable instructions for implementing the specified logical functions. It should also be noted that, in some alternative implementations, the functions marked in the blocks may also occur in an order different from that marked in the drawings. For example, two blocks shown in succession may actually be executed substantially in parallel, or they may sometimes be executed in the reverse order, depending on the functions involved. It should also be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The involved modules described in the embodiments of the present disclosure may be implemented by software or hardware. The name of a module does not constitute a limitation on the module itself under certain circumstances.

The functions described herein above may be performed at least in part by one or more hardware logic components. For example, without limitation, exemplary types of hardware logic components that may be used include: field programmable gate array (FPGA), application specific integrated circuit (ASIC), application specific standard product (ASSP), system on chip (SOC), complex programmable logical device (CPLD) and so on.

In the context of the present disclosure, a machine-readable medium may be a tangible medium that may contain or store programs for use by or in combination with an instruction execution system, apparatus or device. The machine-readable medium may be a machine-readable signal medium or a machine-readable storage medium. The machine-readable medium may include, but is not limited to, an electrical, magnetic, optical, electromagnetic, infrared, or semiconductor system, apparatus or device, or any suitable combination of the above. More specific examples of the machine-readable storage medium would include an electrical connection based on one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the above.

According to one or more embodiments of the present disclosure, Example 1 provides a content display method, which includes: playing multimedia content in a target page, and displaying an interactive component in the target page, where the interactive component is used for triggering display of a landing page associated with the multimedia content; and controlling the interactive component to perform different displays following playback of the multimedia content, where in a first playback stage of the multimedia content, the interactive component is used for displaying a preset effect, and in a second playback stage of the multimedia content, a first display area of the interactive component is used for displaying the preset effect, and a second display area of the interactive component is used for displaying text information and/or picture information related to the multimedia content.

According to one or more embodiments of the present disclosure, Example 2 provides the content display method of Example 1, and controlling the interactive component to perform different displays following the playback of the multimedia content includes: controlling the interactive component to display a first preset effect when the multimedia content is in the first playback stage within a first duration; and controlling the interactive component to display a second preset effect when the multimedia content is in the first playback stage within a second duration, where the second preset effect is different from the first preset effect.

According to one or more embodiments of the present disclosure, Example 3 provides the content display method of Example 1, and controlling the interactive component to perform different displays following the playback of the multimedia content includes: displaying a preset color effect in the interactive component when the multimedia content is in the first playback stage; and the content display method further includes: displaying a preset animation effect in the interactive component and/or at a preset position around the interactive component when the multimedia content is in the first playback stage.

According to one or more embodiments of the present disclosure, Example 4 provides the content display method of Example 1, and controlling the interactive component to perform different displays following the playback of the multimedia content includes: displaying a plurality of text information items and/or a plurality of picture information items related to the multimedia content in the second display area of the interactive component in a carousel manner when the multimedia content is in the second playback stage.

According to one or more embodiments of the present disclosure, Example 5 provides the content display method of any one of Examples 1-4, the preset effect includes a flowing light effect, and/or when the multimedia content is video content, a color of the preset effect is determined according to a main hue of the video content.

According to one or more embodiments of the present disclosure, Example 6 provides the content display method of any one of Examples 1-4, and controlling the interactive component to perform different displays following the playback of the multimedia content includes: controlling the interactive component to display a preset initial style when the multimedia content is in a third playback stage, where the third playback stage is before the first playback stage, and the first playback stage is before the second playback stage.

According to one or more embodiments of the present disclosure, Example 7 provides the content display method of any one of Examples 1-4, and playing the multimedia content in the target page, and displaying the interactive component in the target page includes: displaying a feed page, where the feed page is used for a user to continuously browse a plurality of video content items; and playing the multimedia content in the target page, and displaying the interactive component on an upper layer of the multimedia content in response to a browsing operation of the user on the feed page.

According to one or more embodiments of the present disclosure, Example 8 provides a content display apparatus, which includes: a first display module, configured to play multimedia content in a target page, and display an interactive component in the target page, where the interactive component is used for triggering display of a landing page associated with the multimedia content; and a second display module, configured to control the interactive component to perform different displays following playback of the multimedia content, where in a first playback stage of the multimedia content, the interactive component is used for displaying a preset effect, and in a second playback stage of the multimedia content, a first display area of the interactive component is used for displaying the preset effect, and a second display area of the interactive component is used for displaying text information and/or picture information related to the multimedia content.

According to one or more embodiments of the present disclosure, Example 9 provides a computer-readable medium having a computer program stored thereon, where the program, when executed by a processing apparatus, implements the steps of the content display method of any one of Examples 1-7.

According to one or more embodiments of the present disclosure, Example 10 provides an electronic device, which includes: a storage apparatus having a computer program stored thereon; and a processing apparatus, configured to execute the computer program in the storage apparatus to implement the steps of the content display method of any one of Examples 1-7.

According to one or more embodiments of the present disclosure, Example 11 provides a computer program product including a computer program, where the computer program, when executed by a processor, implements the steps of the content display method of any one of Examples 1-7.

The above description is only preferred embodiments of the present disclosure and an explanation of the applied technical principles. Those skilled in the art should understand that the disclosure scope involved in the present disclosure is not limited to the technical solution formed by a specific combination of the above technical features, and should also cover other technical solutions formed by any combination of the above technical features or their equivalent features without departing from the above disclosure concept. For example, the above features and the technical features provided in the present disclosure (but not limited to) with similar functions replace each other to form a technical solution.

In addition, although the operations are depicted in a specific order, this should not be understood as requiring these operations to be performed in a specific order shown or in a sequential order. Under certain circumstances, multitasking and parallel processing may be beneficial. Similarly, although the above discussion contains a number of specific implementation details, these should not be interpreted as limiting the scope of the present disclosure. Certain features described in the context of separate embodiments may also be implemented in a single embodiment in combination. On the contrary, various features described in the context of a single embodiment may also be implemented in a plurality of embodiments individually or in any suitable sub-combination.

Although the subject matter has been described in language specific to structural features and/or logical actions of the method, it should be understood that the subject matter defined in the appended claims is not necessarily limited to the specific features or actions described above. On the contrary, the specific features and actions described above are only exemplary forms for implementing the claims. Regarding the apparatus in the above embodiments, the specific manner in which each module performs operations has been described in detail in the embodiments of the method, and will not be detailed here.

We claim:

1. A content display method, comprising:
playing multimedia content in a target page, and displaying an interactive component in the target page, wherein the interactive component is configured to trigger display of a landing page associated with the multimedia content; and
controlling, following playback of the multimedia content, the interactive component to perform different displays, wherein in a first playback stage of the multimedia content, the interactive component is configured to display a preset visual effect, and in a second playback stage of the multimedia content, a first display area of the interactive component is configured to display the preset effect, and a second display area of the interactive component is configured to display text information and/or picture information related to the multimedia content.

2. The content display method of claim 1, wherein controlling, following the playback of the multimedia content, the interactive component to perform different displays comprises:
controlling, in response to the multimedia content being in the first playback stage within a first duration, the interactive component to display a first preset effect; and
controlling, in response to the multimedia content being in the first playback stage within a second duration, the interactive component to display a second preset effect, wherein the second preset effect is different from the first preset effect.

3. The content display method of claim 1, wherein controlling, following the playback of the multimedia content, the interactive component to perform different displays comprises:
displaying, in response to the multimedia content being in the first playback stage, a preset color effect in the interactive component; and wherein
the content display method further comprises:
displaying, in response to the multimedia content being in the first playback stage, a preset animation effect in the interactive component and/or at a preset position around the interactive component.

4. The content display method of claim 1, wherein controlling, following the playback of the multimedia content, the interactive component to perform different displays comprises:
displaying, in response to the multimedia content being in the second playback stage, a plurality of text information items and/or a plurality of picture information items related to the multimedia content in the second display area of the interactive component in a carousel.

5. The content display method of claim 1, wherein the preset effect comprises a flowing light effect, and/or in response to the multimedia content being video content, a color of the preset effect is determined based on a main hue of the video content.

6. The content display method of claim 1, wherein controlling, following the playback of the multimedia content, the interactive component to perform different displays comprises:
controlling, in response to the multimedia content being in a third playback stage, the interactive component to display a preset initial style, wherein the third playback stage is before the first playback stage, and the first playback stage is before the second playback stage.

7. The content display method of claim 1, wherein playing the multimedia content in the target page, and displaying the interactive component in the target page comprises:
displaying a feed page, wherein the feed page is configured to enable a user to continuously browse a plurality of video content items; and
in response to a browsing operation of the user on the feed page, playing the multimedia content in the target page, and displaying the interactive component on an upper layer of the multimedia content.

8. A non-transitory computer-readable medium having a computer program stored thereon, wherein the computer program, when executed by a processor, causes the processor to:
play multimedia content in a target page, and display an interactive component in the target page, wherein the interactive component is configured to trigger display of a landing page associated with the multimedia content; and
control, following playback of the multimedia content, the interactive component to perform different displays, wherein in a first playback stage of the multimedia content, the interactive component is configured to display a preset visual effect, and in a second playback stage of the multimedia content, a first display area of the interactive component is configured to display the preset effect, and a second display area of the interactive component is configured to display text information and/or picture information related to the multimedia content.

9. The non-transitory computer-readable medium according to claim 8, wherein the computer program causing the processor to control, following the playback of the multimedia content, the interactive component to perform different displays further causes the processor to:
control, in response to the multimedia content being in the first playback stage within a first duration, the interactive component to display a first preset effect; and
control, in response to the multimedia content being in the first playback stage within a second duration, the interactive component to display a second preset effect, wherein the second preset effect is different from the first preset effect.

10. The non-transitory computer-readable medium according to claim 8, wherein the computer program causing the processor to control, following the playback of the multimedia content, the interactive component to perform different displays further causes the processor to:
display, in response to the multimedia content being in the first playback stage, a preset color effect in the interactive component; and wherein
the computer program further causes the processor to:
display, in response to the multimedia content being in the first playback stage, a preset animation effect in the interactive component and/or at a preset position around the interactive component.

11. The non-transitory computer-readable medium according to claim 8, wherein the computer program causing the processor to control, following the playback of the multimedia content, the interactive component to perform different displays further causes the processor to:
display, in response to the multimedia content being in the second playback stage, a plurality of text information items and/or a plurality of picture information items related to the multimedia content in the second display area of the interactive component in a carousel.

12. The non-transitory computer-readable medium according to claim 8, wherein the preset effect comprises a flowing light effect, and/or in response to the multimedia content being video content, a color of the preset effect is determined based on a main hue of the video content.

13. The non-transitory computer-readable medium according to claim 8, wherein the computer program causing the processor to control, following the playback of the multimedia content, the interactive component to perform different displays further causes the processor to:
control, in response to the multimedia content being in a third playback stage, the interactive component to display a preset initial style, wherein the third playback stage is before the first playback stage, and the first playback stage is before the second playback stage.

14. The non-transitory computer-readable medium according to claim 8, wherein the computer program causing the processor to play the multimedia content in the target page, and display the interactive component in the target page further causes the processor to:
display a feed page, wherein the feed page is configured to enable a user to continuously browse a plurality of video content items; and
in response to a browsing operation of the user on the feed page, play the multimedia content in the target page, and display the interactive component on an upper layer of the multimedia content.

15. An electronic device, comprising:
a memory having a computer program stored thereon; and
a processor, configured to execute the computer program in the memory to cause the electronic device to:
play multimedia content in a target page, and display an interactive component in the target page, wherein the interactive component is configured to trigger display of a landing page associated with the multimedia content; and
control, following playback of the multimedia content, the interactive component to perform different displays, wherein in a first playback stage of the multimedia content, the interactive component is configured to display a preset visual effect, and in a second playback stage of the multimedia content, a first display area of the interactive component is configured to display the preset effect, and a second display area of the interactive component is configured to display text information and/or picture information related to the multimedia content.

16. The electronic device according to claim 15, wherein the processor causing the electronic device to control, following the playback of the multimedia content, the interactive component to perform different displays further causes the electronic device to:
control, in response to the multimedia content being in the first playback stage within a first duration, the interactive component to display a first preset effect; and
control, in response to the multimedia content being in the first playback stage within a second duration, the interactive component to display a second preset effect, wherein the second preset effect is different from the first preset effect.

17. The electronic device according to claim 15, wherein the processor causing the electronic device to control, following the playback of the multimedia content, the interactive component to perform different displays further causes the electronic device to:
display, in response to the multimedia content being in the first playback stage, a preset color effect in the interactive component; and wherein
the processor further causes the electronic device to:
display, in response to the multimedia content being in the first playback stage, a preset animation effect in the interactive component and/or at a preset position around the interactive component.

18. The electronic device according to claim 15, wherein the processor causing the electronic device to control, following the playback of the multimedia content, the interactive component to perform different displays further causes the electronic device to:
display, in response to the multimedia content being in the second playback stage, a plurality of text information items and/or a plurality of picture information items related to the multimedia content in the second display area of the interactive component in a carousel.

19. The electronic device according to claim 15, wherein the preset effect comprises a flowing light effect, and/or in response to the multimedia content being video content, a color of the preset effect is determined based on a main hue of the video content.

20. The electronic device according to claim 15, wherein the processor causing the electronic device to control, following the playback of the multimedia content, the interactive component to perform different displays further causes the electronic device to:
control, in response to the multimedia content being in a third playback stage, the interactive component to display a preset initial style, wherein the third playback stage is before the first playback stage, and the first playback stage is before the second playback stage.
